(19) United States
(12) Patent Application Publication
(10) Pub. No.: US 2012/0324803 A1
(43) Pub. Date: Dec. 27, 2012

(54) Method and Device for Watering a Hanging or Potted Plant

(76) Inventors: Selby Sullivan, Oviedo, FL (US); Ronald G. Presswood, JR., Houston, TX (US)

(21) Appl. No.: 13/530,677

(22) Filed: Jun. 22, 2012

Related U.S. Application Data
(60) Provisional application No. 61/499,862, filed on Jun. 22, 2011.

(51) Int. Cl. E04B 7/18; E04D 13/00; A01G 27/00; E04D 13/064

(52) U.S. Cl. 52/12; 52/11; 52/16; 52/173.1

(57) ABSTRACT

A rainwater catching and plant watering device includes a collecting member forming a rainwater holding area, the collecting member configured to be attached to a portion of a building from which rainwater will flow. There is at least one opening in the collecting member for receiving rainwater flowing from the building. A flow connector directs rainwater in the water holding area to plants or the like.

### BACKGROUND OF THE INVENTION

1. Field of the Invention

The present invention relates to a method to water plants either hanging or potted using rain water captured from the eave of a roof or gutter.

2. Background of the Invention

Although a number of methods exist to water plants such as using a hose or drip irrigation system which require access to a pressured water system, or the use of a pitcher or other manual system such as plant water globes, if the water pressure fails or the plant owner does not water the plant, the plant will die. There are currently no methods of capturing rain water from the roof or gutter system and redirecting this water to the either a potted or hanging plant.

Thus, there is a need in the art for an improved method to economically capture rainwater directly from the roof or gutter system of the house and redirecting this water to a potted or hanging plant.

### SUMMARY OF THE INVENTION

The present invention provides an apparatus for capturing rain water from the roof or the gutter system.

The present invention can be attached directly blow the drip line of the roof to capture rainwater and then redirect the captured rainwater to a potted or hanging plant. The present invention is envisioned to capture and store rainwater in a capture basin, this water is then directed to the plant through a hose or tube. The flow can be open flow or can be controlled by use of a valve or metering system. But at the same time a design can be created that does not have a capture basin to hold the rainwater, the water is directly fed to the plant.

The present invention can be attached to the roofing system eave drip, directly blow the drip line of the roof to capture rainwater and then redirect the captured rainwater to a potted or hanging plant. The present invention is envisioned to capture and store rainwater in a capture basin. This water is then directed to the plant through a hose or tube. The flow can be open flow or can be controlled by use of a valve or metering system. But at the same time a design can be created that does not have a capture basin to hold the rainwater, the water is directly fed to the plant.

The present invention can also be attached directly below the gutter system. The unit is attached by drilling a hole into the bottom of the gutter, a unique attachment will fasten the unit to the gutter and at the same time allow water to pass from the gutter to the attached catch basin. The catch basin is used to capture rainwater and then redirect the captured rainwater to a potted or hanging plant. The present invention is envisioned to capture and store rainwater in a capture basin, this water is then directed to the plant through a hose or tube. The flow can be open flow or can be controlled by use of a valve or metering system.

The present invention can also be attached directly into the gutter system. The unit is attached by drilling a hole into the bottom of the gutter, and a unique attachment will fasten into the gutter.

The present invention is also envisioned to utilize the gutter system as a capture basin to capture and store rainwater. This water is then directed to the plant through a hose or tube. In addition to the capture tool a dam can be placed down flow from the capture tool to retain more water in the gutter system to allow for more water to be directed to the plant. The flow can be open flow or can be controlled by use of a valve or metering system.

### BRIEF DESCRIPTION OF THE DRAWINGS

The invention can be better understood when the detailed description of the invention is considered in conjunction with the drawings, in which:

FIG. 1 shows an embodiment that can be attached to a roofing system eave drip;

FIG. 2 shows another embodiment that can be attached to a roofing system eave drip;

FIG. 3 shows an embodiment that can be attached under a gutter system;

FIGS. 4 and 5 show an embodiment that can be attached in a gutter.

### DETAILED DESCRIPTION OF THE INVENTION

The present invention can be attached directly blow the drip line of the roof to capture rainwater and then redirect the captured rainwater to a potted or hanging plant. The present invention is envisioned to capture and store rainwater in a capture basin. This water is then directed to the plant through a hose or tube. The flow can be open flow or can be controlled by use of a valve or metering system. But at the same time a design can be created that does not have a capture basin to hold the rainwater, the water is directly fed to the plant. The rain catching portion of the unit can be made from plastic material such as but not limited to ABS, PVC, HDPE, LDPE, this can either be injection molded or vacuum formed, additionally the unit could be made from metal such as but not limited to Aluminum, Steel, Copper etc., this can be pressed formed or made from folded metal. The tubing can be made from plastic such as but not limited to PVC, PE, HDPE, LDPE etc., or a metal such as aluminum, copper, steel etc.

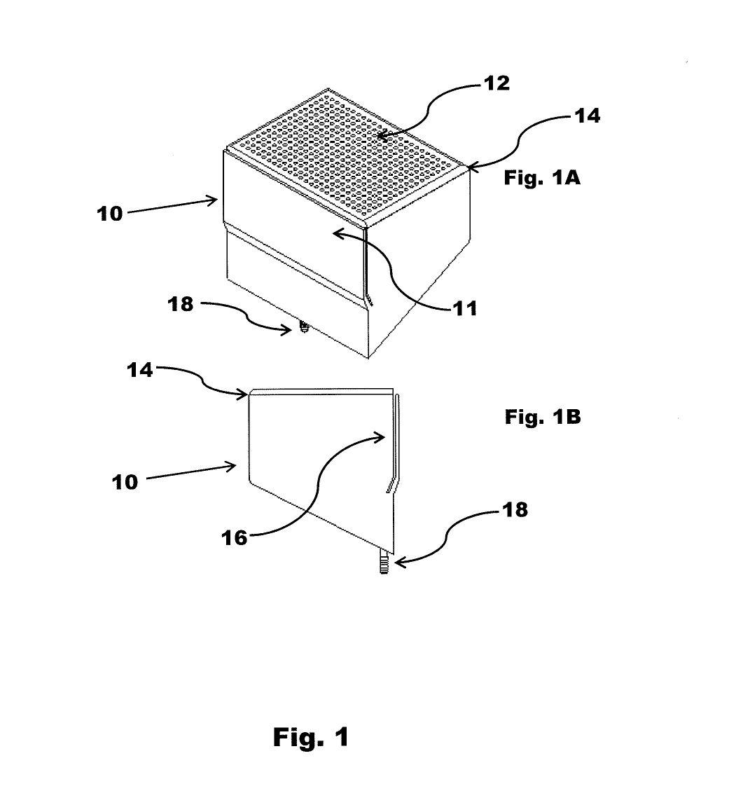

An embodiment of the present invention, which can be attached to the roofing system eave drip, is shown in FIG. 1. A capture basin 10 is attached by any suitable means directly blow the drip line of the roof to capture rainwater and then redirect the captured rainwater to a potted or hanging plant. The capture basin 10 includes a screened top 12 for preventing debris such as fallen leaves from blocking the flow of rainwater from the capture basin 10. The screened top is connected to the main body of the capture basin by means of a hinge connection or a snap feature along the side 14 of the screened top so the screened top can be lifted for cleaning the capture basin. A cutout with a profile matching the standard shape of eave drip is manufactured in the body 16 is used to secure the capture basin to the eave drip. A flow connector 18 is located at the bottom of the capture basin for directing stored rainwater from a port or opening (not shown) formed in the capture basin, into a tube (not shown) connected to the flow connector so rainwater can be directed to plants or the like. The flow connector can have a ridged or tapered outer surface for holding a plastic tube that is pushed over and held in place on the outer surface. The flow connector can also include an impeding member in the form of a valve or metering device (not shown) for impeding and controlling the flow of rainwater through the flow connector. The impeding member can be formed of a fibrous material such as a filter or a porous insert such as an airstone, which is positioned in or adjacent to the opening of the flow connector.

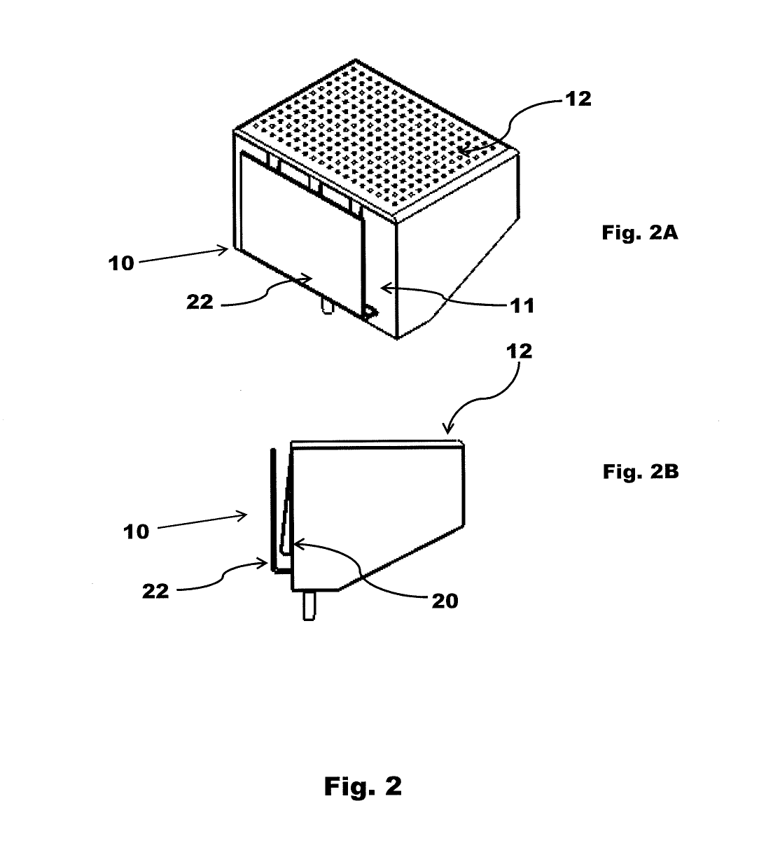

Another embodiment of the invention, which can also be attached to the roofing system eave drip, is shown in FIG. 2. The capture basin 10 is similar in shape to the one in FIG. 1, where the screened top 12 is connected to the main body of the capture basin by means of a hinge connection or a snap feature along the side 14 of the screened top so the screened top can be lifted for cleaning the capture basin. The basin has a exterior plastic feature 20 that extends outside the front wall 11. A holding plate 22 is attached to the front wall 11 of the capture basin and is spaced apart from the front wall 11, as shown, so the eave drip can fit between the front wall 11, and plastic feature 20 and the holding plate 22, for securing the basin.

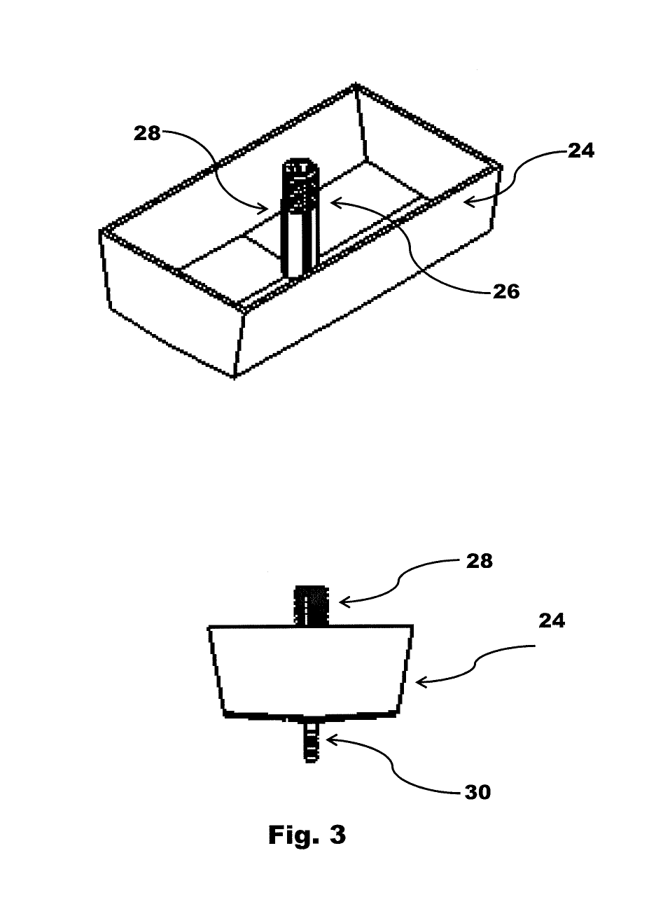

The present invention can also be attached directly below the gutter system. As shown in FIG. 3, a capture basin 24 is designed to be attached to the bottom of a gutter (not shown). The capture basin 24 is attached to the gutter by drilling a hole into the bottom of the gutter and inserting a stem 26 with a threaded upper end 28 for receiving a nut (not shown) for attaching the capture basin to the gutter. A flow connector 30 is connected to the bottom of the capture basin, similar to the other embodiments, for directing rainwater in the capture basin to plants or the like.

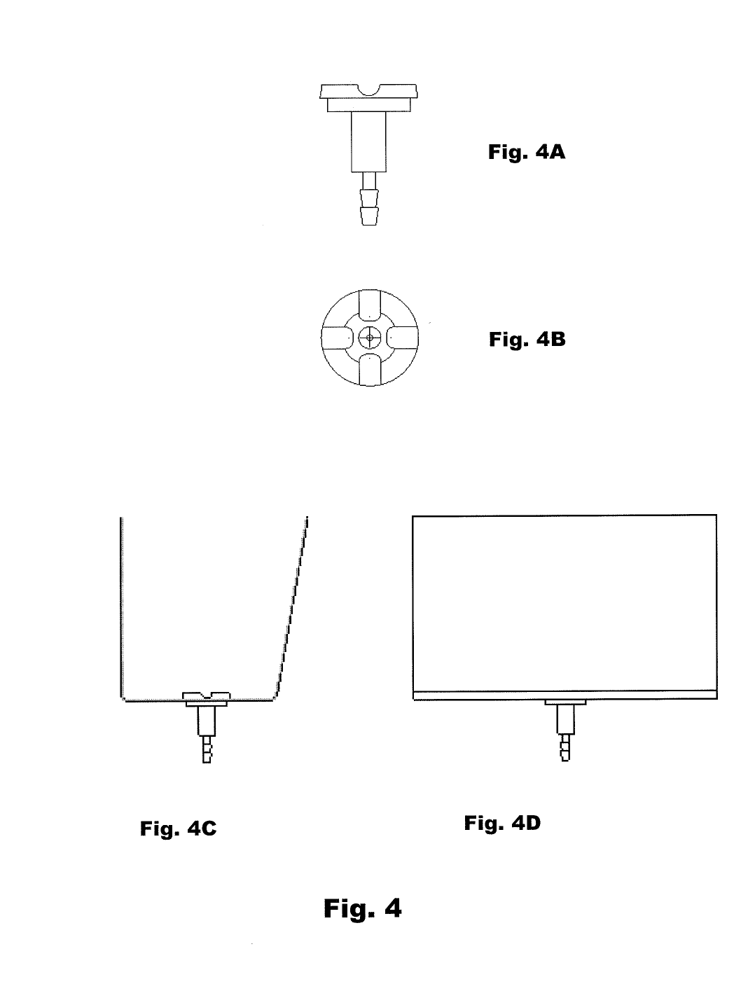

The present invention can also include a capture tool in the form of a flow connector that can be attached directly into the gutter system for using the gutter as a capture basin to capture and store rainwater. A flow connector 32 shown in FIGS. 4A and 4B can be inserted through a hole formed in the bottom of the gutter. The connector is tapered at 34 to create an interference fit when the flow connector is installed to the gutter 38, as shown in FIGS. 4C and 4D. The flow connector 32 could also be installed in the gutter by means of a threaded fitting, screws or rivets or other suitable mechanical means or by use of an adhesive such as Silicon, epoxy, or similar means. In addition, a dam (not shown) can be placed in the gutter, preferable down flow from the flow connector to retain more water in the gutter system to allow for more water to be directed to the plant.

The invention can be modified or improved with features that fall within the spirit and scope of the invention as described, and it is intended that all such modifications and improvements will fall within the scope of the appended claims.

1. A rainwater catching and plant watering device, comprising:
a collecting member forming a rainwater holding area, the collecting member configured to be attached to a portion of a building from which rainwater will flow;
at least one opening in the collecting member for receiving rainwater flowing from the building;
a flow connector for directing rainwater in the water holding area to plants or the like.

2. The device according to claim 1, wherein and further including an impeding member positioned in or adjacent to the flow connector for impeding and controlling the flow of rainwater through the flow connector.

3. The device according to claim 1, wherein the impeding member is an airstone disposed adjacent to an opening in the collecting member.

4. The device according to claim 1, wherein the conduit includes a portion having a plurality of openings therein to release the water.

5. The device according to claim 1, wherein the collecting member is a gutter.

6. The device according to claim 1, wherein the collecting member includes a capture basin adapted to be connected to said building.

7. The device according to claim 1, further comprising a debris blocking element disposed adjacent the at least one opening to prevent debris from blocking the opening

8. The device according to claim 1, further comprising an attaching member attached to the collecting member to attach the device to the building.

9. The device according to claim 1, wherein the attaching member is an elastic clip.

10. The device according to claim 1, wherein at least a portion of one of the at least two sides is configured to engage at least the portion of a building from which rainwater will flow.

11. The device according to claim 1, wherein the at least one opening includes a plurality of openings.

12. A rain catching and plant watering device comprising:
a collecting member having at least two sides and a bottom defining a water holding area to collect water from a gutter;
at least one opening in the collecting member;
a conduit in fluid communication with the water holding area and having a length sufficient to reach plants or the like; and
an impeding member to slow the flow of water from the water holding area through the conduit.

13. The device according to claim 12, wherein the impeding member is a fibrous element disposed in the conduit.

14. The device according to claim 12, wherein the impeding member is an airstone disposed adjacent the opening in bottom.

15. The device according to claim 12, wherein the conduit includes a portion having a plurality of openings therein to release the water.

16. A rain catching and plant watering device comprising:
a collecting member that is fitted into a gutter with a top surface and surface extending below the gutter, the collecting member configured to be fitted into a hole cut into a gutter;
at least one opening in the collecting member;
a conduit having a length sufficient to reach plants or the like; and
an impeding member to slow the flow of water from the water holding area through the conduit.

17. The device according to claim 16, wherein the impeding member is a fibrous element disposed in the conduit.

18. The device according to claim 16, wherein the impeding member is an airstone disposed adjacent the opening in bottom.

19. The device according to claim 16, wherein the conduit includes a portion having a plurality of openings therein to release the water.

20. The device according to claim 16, further comprising a debris blocking element disposed adjacent the at least one opening to prevent debris from blocking the opening

21. The device according to claim 16, wherein the at least one opening includes a plurality of openings.
